(19) United States
(12) Patent Application Publication
(10) Pub. No.: US 2025/0162858 A1
(43) Pub. Date: May 22, 2025

(54) SPRING HANDLING APPARATUS AND METHOD

(71) Applicant: HS PRODUCTS LTD, Leeds (GB)

(72) Inventor: David Clare, Leeds (GB)

(21) Appl. No.: 18/841,234

(22) PCT Filed: Feb. 23, 2023
(86) PCT No.: PCT/GB2023/050417

§ 371 Date: Aug. 23, 2024

(30) Foreign Application Priority Data
Feb. 23, 2022 (GB) 2202481.4

(51) Int. Cl. B68G 9/00

(52) U.S. Cl. CPC B68G 9/00

(57) ABSTRACT

Spring transfer apparatus comprises a wheel (200), having a hub (210) and a plurality of spokes (220) extending radially therefrom and arranged to receive between them individual coil springs S produced in a coiling head, represented at (220) via a pair of rotating transfer brushes (230). In use, the wheel is driven to rotate in the direction of Arrows A1. At their distal ends, the spokes pass through a slotted compression chute (240) and the springs S located between the spokes become compressed during their passage through the chute. When the springs reach the lowermost point in the rotation, at which they are maximally compressed, the springs are pushed axially with respect to the hub (210) towards pre-prepared webs W of pocketing material that have been joined together at locations L to form pockets P for receiving the springs and which are travelling in the direction of Arrow A2.

The present invention relates to a spring handling apparatus, and to a method of handling springs, particularly for the handling of springs used in the manufacture of pocketed spring units, such as are used in mattress cores.

In recent times, the rate at which coil springs can be formed at a coiling head has increased significantly. However, the rate at which the springs can be inserted into positions between plies of pocketing material, for the manufacture of pocketed- or encased-spring units, has not kept pace.

Embodiments of the present invention aim to provide a spring handling apparatus and method that address the problems with previous apparatus and methods.

The present invention is defined in the attached independent claims, to which reference should now be made. Further, preferred features may be found in the sub-claims appended thereto.

According to one aspect of the present invention, there is provided a transfer apparatus for transferring springs from a spring forming station into positions between plies of pocketing material to form a pocketed spring unit, the transfer apparatus being positionable in use between the spring forming station and a pocketing station, and comprising a transfer wheel arranged to rotate about a rotation axis and having a plurality of spokes extending substantially radially in a spoke plane, wherein the wheel is flanked by axially spaced containment members extending either side of the spoke plane, and wherein the transfer wheel comprises one or more spring receiving portions formed between adjacent spokes, the spring receiving portions being arranged to travel in an arcuate path between the containment members from the spring forming station to a location where the springs may be inserted into positions between plies of pocketing material.

In a preferred arrangement the containment members are arranged to extend substantially parallel to the spoke plane and either side thereof.

The apparatus may comprise a compression portion arranged to compress the spring axially as the wheel rotates. In a preferred arrangement, the compression portion comprises a pair of spaced compression members between which the spring is arranged to pass as the wheel rotates. The compression members may be arranged to converge in the direction of movement of the spring and preferably comprise a pair of plates.

The apparatus preferably comprises a pusher arranged to push the spring from between the spoke portions. The pusher may be arranged to push the spring after it has been compressed, more preferably to push the spring into a position between plies of pocketing material.

According to another aspect of the present invention, there is provided a method of transferring springs from a spring forming station into positions between plies of pocketing material to form a pocketed spring unit, the transfer apparatus being positionable in use between the spring forming station and a pocketing station, and comprising a transfer wheel arranged to rotate about a rotation axis and having a plurality of spokes extending substantially radially in a spoke plane, wherein the wheel is flanked by axially spaced containment members extending either side of the spoke plane, and wherein the transfer wheel comprises one or more spring receiving portions formed between adjacent spokes, the method comprising introducing the springs into the spring receiving portions and causing the spring receiving portions to travel in an arcuate path between the containment members from the spring forming station to a location where the springs may be inserted into positions between plies of pocketing material.

In a further aspect, the invention provides a computer programme product on a computer readable medium, comprising instructions that, when executed by a computer, cause the computer to perform a method according to any statement herein.

The invention also comprises a program for causing a device to perform a method according to any statement herein.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

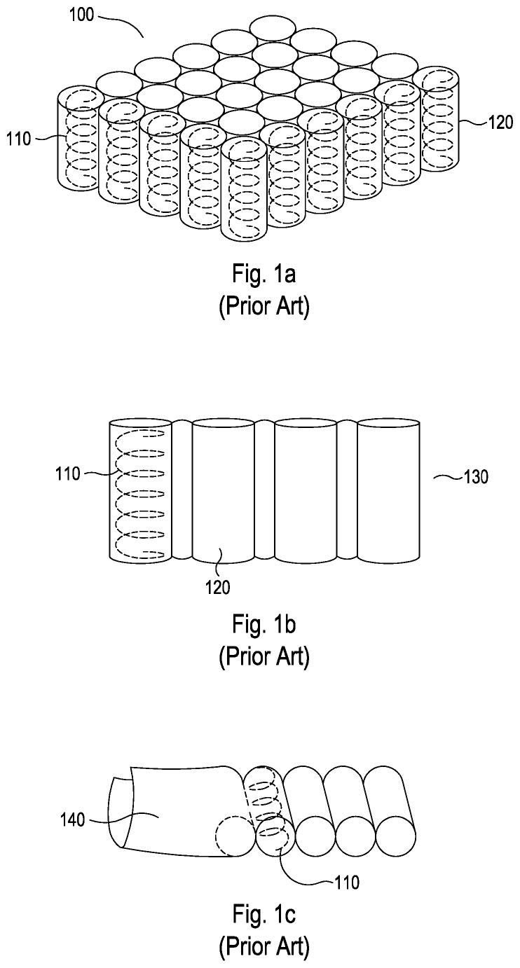

FIGS. 1a to 1c show schematically a previously considered typical core component for a mattress;

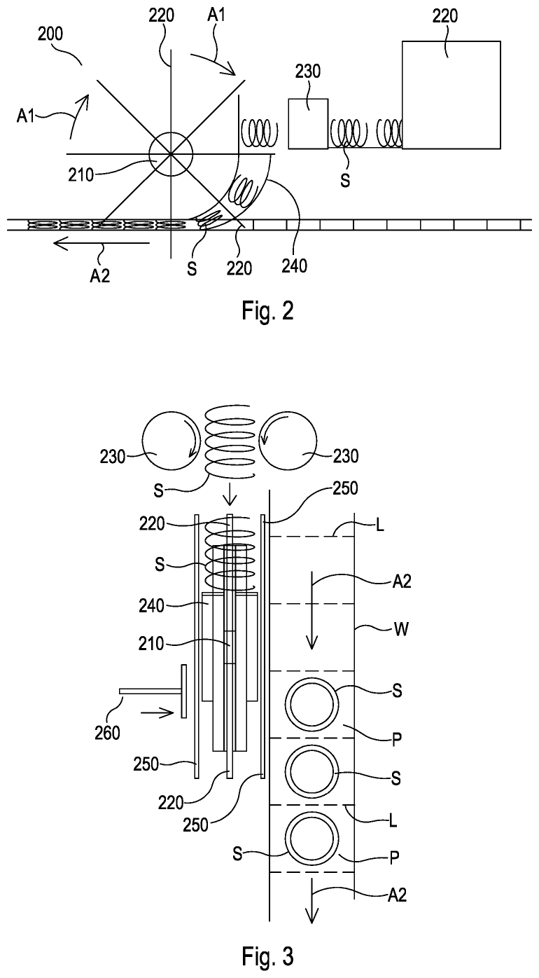

FIG. 2 is a schematic side view showing a spring transfer apparatus according to an embodiment of the present invention; and

FIG. 3 is a schematic plan view of the apparatus of FIG. 2.

Turning to FIG. 1, this shows, generally at 100, a part of a resilient unit such as is used typically in a mattress core. The resilient unit comprises an array of metallic coil springs 110 located in individual pockets 120 of material, which is typically spun-bonded polyester. The array is actually made up of a number of linear “strings” of pocketed springs which are secured together, for example by ultrasonic welding. FIG. 1(b) shows one such string of springs 130. The string is formed by placing a number of springs 110 on their sides onto a sheet 140 of pocketing material and folding the sheet over the springs before welding the two leaves of material together at their edges and between the springs.

FIG. 2 shows an embodiment of spring transfer apparatus according to the present invention.

The apparatus comprises a wheel 200, having a hub 210 and a plurality of spokes 220 extending radially therefrom and arranged to receive between them individual coil springs S produced in a coiling head, represented at 220 via a pair of rotating transfer brushes 230. In use, the wheel is driven to rotate in the direction of Arrows A1. At their distal ends, the spokes pass through a slotted compression chute 240 and the springs S located between the spokes become compressed during their passage through the chute.

When the springs reach the lowermost point in the rotation, at which they are maximally compressed, the springs are pushed axially with respect to the hub 210 towards pre-prepared webs W of pocketing material that have been joined together at locations L to form pockets P for receiving the springs and which are travelling in the direction of Arrow A2.

FIG. 3 shows the apparatus of FIG. 2 from above. In addition to the chute 240, a pair of containment plates 250, axially spaced either side of the spokes, keep the springs in position between the spokes. A cam-controlled pusher 260 pushes the springs from between the spokes into the pre-formed pockets P.

Because the springs are transferred to the pocketing webs between the spokes, as opposed to being carried on the spokes (as is the case in some previously considered apparatus) there is no need to stop the rotation of the wheel, even momentarily, either when the springs are loaded onto the wheel or when the springs are pushed into the pockets. This continuous motion of the transfer wheel enables a faster transfer rate, in keeping with the increasing speed of spring production.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A transfer apparatus for transferring springs from a spring forming station into positions between plies of pocketing material to form a pocketed spring unit, the transfer apparatus being positionable in use between the spring forming station and a pocketing station, and comprising a transfer wheel arranged to rotate about a rotation axis and having a plurality of spokes extending substantially radially in a spoke plane, wherein the wheel is flanked by axially spaced containment members extending either side of the spoke plane, and wherein the transfer wheel comprises one or more spring receiving portions formed between adjacent spokes, the spring receiving portions being arranged to travel in an arcuate path between the containment members from the spring forming station to a location where the springs may be inserted into positions between plies of pocketing material.

2. An apparatus according to claim 1, wherein the containment members are arranged to extend substantially parallel to the spoke plane and either side thereof.

3. An apparatus according to claim 1, or 2, wherein the apparatus further comprises a compression portion arranged to compress the spring axially as the wheel rotates.

4. An apparatus according to claim 3, wherein the compression portion comprises a pair of spaced compression members between which the spring is arranged to pass as the wheel rotates.

5. An apparatus according to claim 4, wherein the compression members are arranged to converge in the direction of movement of the spring and comprise a pair of plates.

6. An apparatus according to claim 1, any of the preceding claims, wherein the apparatus further comprises a pusher arranged to push the spring from between the spoke portions.

7. An apparatus according to claim 6, wherein the pusher is arranged to push the spring into a position between plies of pocketing material after it has been compressed.

8. A method of transferring springs from a spring forming station into positions between plies of pocketing material to form a pocketed spring unit, the transfer apparatus being positionable in use between the spring forming station and a pocketing station, and comprising a transfer wheel arranged to rotate about a rotation axis and having a plurality of spokes extending substantially radially in a spoke plane, wherein the wheel is flanked by axially spaced containment members extending either side of the spoke plane, and wherein the transfer wheel comprises one or more spring receiving portions formed between adjacent spokes, the method comprising introducing the springs into the spring receiving portions and causing the spring receiving portions to travel in an arcuate path between the containment members from the spring forming station to a location where the springs may be inserted into positions between plies of pocketing material.
